(19) United States
(12) Patent Application Publication
(10) Pub. No.: US 2025/0007437 A1
(43) Pub. Date: Jan. 2, 2025

(54) Inverter for controlling an electrical machine, method of operating the inverter and safety control device

(71) Applicant: SEG Automotive Germany GmbH, Stuttgart (DE)

(72) Inventor: Nima SAADAT, Stuttgart (DE)

(21) Appl. No.: 18/753,076

(22) Filed: Jun. 25, 2024

(30) Foreign Application Priority Data
Jun. 28, 2023 (DE) 102023117024.4

(51) Int. Cl. H02P 27/06; H02P 29/024

(52) U.S. Cl. CPC H02P 27/06; H02P 29/0241

(57) ABSTRACT

An inverter for controlling an electrical machine, the inverter having a high-voltage branch, a low-voltage branch and a backup supply branch, an operating DC/DC converter, which is connected on the one hand to the high-voltage branch and on the other hand to the low-voltage branch, a backup supply DC/DC converter, which is connected on the one hand to the low-voltage branch and on the other hand to the backup supply branch, and an inverter circuit for connecting the high-voltage branch to AC voltage terminals for the electrical machine. The inverter circuit and a safety control device are supplied with energy from the low-voltage branch and the safety control device may be set up to switch the inverter circuit to a safe state when a shutdown situation occurs, wherein the inverter circuit and the safety control device are supplied or can be supplied with energy from the backup supply branch.

### CROSS-REFERENCE TO RELATED APPLICATIONS

This application claims priority to German Patent Application No. 102023117024.4 filed Jun. 28, 2023, which is hereby incorporated by reference.

### TECHNICAL FIELD

The present invention relates to an inverter for controlling an electrical machine, a method for operating the inverter and a safety control device.

### BACKGROUND

A power supply circuit of an inverter or in an inverter is also referred to as a PDN or PDTN (power distribution network or power distribution network tree) in modern vehicle applications with an electric drive. The task of this power distribution network is, among other things, to distribute power to the various consumers of the inverter, such as sensors, communication circuits (e.g. CAN, LIN transceivers) and in particular the gate driver circuits for high-side (HS) and low-side (LS) switches, and functional safety circuits or MCU (microcontroller unit), etc. In this sense, the inverter is a device which internally has the power supply circuit and components supplied by it, including switches, e.g. in the form of half bridges, and connections for connecting external power sources and an electrical machine.

Nowadays, due to functional safety requirements, there can be two main power sources for the PDN. A common power source in electric vehicles (EV) is low-voltage batteries (e.g. 12 V), also known as the KL30 network or low-voltage network. A second source can be a high-voltage DC battery or the high-voltage DC bus (high-voltage grid) with a nominal voltage of 800 V or 400 V, for example. Such high-voltage or high-voltage systems can be used in particular as a power supply for an electric traction drive, such as a permanent magnet synchronous motor (PMSM), which is connected to the high-voltage grid via the inverter.

In the event of an incident or an emergency shutdown, the inverter should switch to a predefined safe state. To prevent the DC link capacitors from being charged by the electrical machine (especially when using PMSM), the active short circuit (ASC) technique is usually used, whereby all low-side (LS) switches or all high-side (HS) switches are closed, thereby stopping the transfer of energy from the electrical machine to the DC link.

### SUMMARY

According to the disclosure, an inverter for controlling an electrical machine, in particular in a vehicle, a method for operating the inverter and a safety control device with the features of the independent patent claims are proposed. Advantageous embodiments are the subject of the dependent claims and the following description. It should be emphasized that the features and advantages described below apply equally to the inverter and the method for operating such an inverter.

The disclosure describes a way of improving the power supply in an inverter in such a way that a safe state of the inverter or the electrical machine in the vehicle is reliably achieved even in the event of a fault.

Specifically, the inverter has at least three different supply branches, namely a high-voltage branch, a low-voltage branch and a backup supply branch. The high-voltage branch is set up to be connected to a high-voltage network (in particular in the vehicle), and the low-voltage branch is set up to be connected to a low-voltage network (in particular in the vehicle), wherein a nominal voltage level of the high-voltage network is higher than a nominal voltage level of the low-voltage network. The high-voltage branch and the low-voltage branch have corresponding terminals for connecting to the high-voltage network or low-voltage network, respectively. In particular, these terminals are led out of a housing of the inverter.

The nominal voltage level of the high-voltage network (hereinafter also referred to as the high-voltage level) can, for example, be significantly higher than a permissible touch voltage, in particular 60 V, e.g. up to several hundred volts. For example, high-voltage levels of 400 V or 800 V are often used in current electric vehicles. The nominal voltage level of the low-voltage network and the backup supply branch can, in particular, be essentially the same, i.e. differ from each other by a maximum threshold value of e.g. 5 V, and can, for example, correspond to standard vehicle low voltages of e.g. 12 V or 24 V.

The high-voltage branch is connected to the low-voltage branch via an operating DC/DC converter, and the low-voltage branch is connected to the backup supply branch via a backup supply DC/DC converter that is different from the operating DC/DC converter. In this way, loads in the low-voltage branch can be supplied with power or energy even if there is a problem with the high-voltage branch or the operating DC/DC converter, provided that the DC/DC converters are operated accordingly. In the event of a defect in the operating DC/DC converter, the backup supply branch continues to be supplied. An inverter circuit or power converter circuit for the electrical machine is connected in the high-voltage branch. Since the backup supply DC/DC converter is supplied from the low-voltage branch or low-voltage system, which in principle already has a suitable voltage, it can be designed very simply in terms of electrical engineering and safety. For example, it can be provided that the backup supply DC/DC converter converts the low voltage of 12 V (nominal voltage) to a slightly higher value of e.g. 15 V to 20 V, which is more suitable for supplying electronic components etc.

As is known, an inverter circuit or a power converter circuit is used to connect the AC voltage terminals of the electrical machine to the DC voltage terminals of the high-voltage network. For this purpose, the inverter circuit has a number of semiconductor switches, each of which can be opened (non-conducting) and closed (conducting) in accordance with a control signal. The semiconductor switches can comprise MOSFETs and IGBTs, for example gallium nitride (GaN) or silicon carbide (SIC) FETs.

The inverter circuit, in turn, is supplied with energy or current from the low-voltage branch. In an embodiment, the inverter circuit can have a number of high-side semiconductor switches and a number of low-side semiconductor switches and in each case at least one gate driver circuit for one or more of the semiconductor switches, with the at least one gate driver circuit for the high-side or low-side semiconductor switches being supplied with energy from the low-voltage branch. A gate driver circuit is used to apply a drive signal to a control terminal of a semiconductor switch (e.g. gate terminal of MOSFET). In one embodiment, at least the gate driver circuit of the LS semiconductor switch (hereinafter referred to as LS gate driver circuit) and/or the gate driver circuit of the HS semiconductor switch (hereinafter referred to as HS gate driver circuit) is supplied or can be supplied with energy from the backup supply branch. This means, for example, that a safe state can still be brought about by an active short circuit even in the event of a fault or failure of the low-voltage branch. The at least one gate driver circuit for the high-side or low-side semiconductor switches can be supplied with voltage from at least one bias voltage supply circuit, which in turn can be supplied with energy from the backup supply branch. Alternatively, the at least one gate driver circuit for the high-side or low-side semiconductor switches can also be supplied with energy directly from the backup supply branch, bypassing the bias voltage supply circuit.

The inverter also has a safety control device, which is also supplied with energy from the low-voltage branch. The safety control device is set up to switch the inverter circuit to a safe state if a shutdown situation occurs. In particular, this can be the creation of an active short circuit (determining the type of active short circuit (HS/LS) and closing all HS switches or closing all LS switches). The occurrence of a shutdown situation is determined in particular when a fault occurs or is detected.

To increase functional safety, the inverter circuit and the safety control device can now also be supplied with power from the backup supply branch.

The method according to the disclosure for operating an inverter according to the disclosure comprises bringing the inverter circuit into a safe state when a shutdown situation occurs.

A safety control device according to the disclosure, e.g. an integrated circuit (e.g. IC, ASIC or FPGA), is set up, in particular in terms of program and/or circuit technology, to carry out a method according to the disclosure.

The disclosed measures significantly increase the functional safety of inverters, which has particular advantages in terms of personal safety, especially in cases with a high-voltage branch. The disclosure requires very few regular components for implementation and is therefore very simple and inexpensive to realize.

In one embodiment, each of the operating DC/DC converter and the backup supply DC/DC converter may optionally be a non-isolating DC/DC converter, such as a buck converter, synchronous converter, SEPIC converter (single ended primary inductance converter), Ćuk converter, zeta converter, etc. With non-isolating DC/DC converters, there is no galvanic isolation between the input network and the output network. These are usually inexpensive to use.

In one embodiment, each of the operating DC/DC converter and the backup supply DC/DC converter can optionally also be an isolating DC/DC converter, such as a fly-back converter, forward converter, push-pull converter, etc. With insulating DC/DC converters, there is galvanic isolation between the input network and the output network, which is usually achieved by means of a transformer. These have increased safety, but are more complex in terms of weight, installation space and costs. In the high-voltage range (>60 V), the use of an insulating DC/DC converter is advantageous or even mandatory for safety reasons.

In one embodiment, a blocking circuit is arranged between the low-voltage branch and the backup supply branch, which prevents a flow of energy between the low-voltage branch and the backup supply branch. This prevents faults in one of the two branches from affecting the other. Such a blocking circuit can in particular have one or more diodes and/or switches at any existing connection points. The switches can include semiconductor switches or mechanical switches (relays). Connection points may exist if a supplied component, such as the inverter circuit, only has one power supply terminal, which must then be connected or connectable to both the low-voltage branch and the backup supply branch. This is a very simple measure in terms of design and circuitry in order to realize a common but non-reactive power supply.

In one embodiment, the low-voltage branch has an mains branch and a supply branch, wherein the inverter circuit and the safety control device are supplied with energy from the supply branch and wherein the mains branch is set up to be connected to a voltage supply, such as the low-voltage network. A second blocking circuit, such as a diode, is arranged between the supply branch and the operating DC/DC converter, which prevents a flow of energy from the supply branch into the operating DC/DC converter, and/or is arranged between the supply branch and the mains branch, which prevents a flow of energy from the supply branch into the mains branch. In this way, faults in the low-voltage system or in the operating DC/DC converter can also be isolated from the supply branch.

In one embodiment, the operating DC/DC converter can be disconnected from the low-voltage branch by means of a first safety disconnector and/or can be disconnected from the high-voltage branch by means of a high-voltage disconnector. This means that in the event of a fault in the low-voltage branch, damage to the operating DC/DC converter or the high-voltage branch can be avoided, or in the event of a fault in the operating DC/DC converter, damage to the low-voltage branch or the high-voltage branch can be avoided.

In one embodiment, the gate driver circuit for the high-side (HS) semiconductor switches can be disconnected from the low-voltage branch by means of a second safety disconnector. This prevents the low-voltage branch from being affected in the event of a fault in the HS gate driver circuit.

In one embodiment, the gate driver circuit for the low-side (LS) semiconductor switches can be disconnected from the low-voltage branch by means of a third safety disconnector circuit. This means that in the event of a fault in the LS gate driver circuit, impairment of the low-voltage branch can be avoided, and in the event of a fault in the low-voltage branch, impairment of the LS gate driver circuit can be avoided. As explained above, the LS gate driver circuit is in particular also supplied or can be supplied from the backup supply branch, so that in the event of a fault in the low-voltage branch, this can or will be disconnected.

In one embodiment, the low-voltage branch can be disconnected from the power supply, such as the low-voltage network, by means of a fourth safety disconnector. In particular, the supply branch can be disconnected from the backup supply branch by means of the fourth safety disconnector. This means that in the event of a fault in the low-voltage branch, damage to the backup supply DC/DC converter or the backup supply branch can be avoided.

In fault-free operation, each of the safety disconnectors and high-voltage disconnectors can be closed or conducting, so that all branches are connected and functional as described above. Each of the safety disconnectors and high-voltage disconnectors can optionally be set up to open, i.e. to switch to a non-conductive state, in response to an external opening signal and/or when a fault is detected, such as when a current threshold value of a current flowing through them is exceeded.

Each of the safety disconnectors and high-voltage disconnectors can optionally comprise one or more semiconductor switches or mechanical switches (relays). The high-voltage disconnectors in particular can also be passively openable and designed in the form of breakers, e.g. also fuses.

In one embodiment, the safety control device is set up to detect the occurrence of a shutdown situation if at least one of the first, second, third and fourth safety disconnectors is in a non-conductive state. This allows a shutdown situation to be reliably detected.

In one embodiment, the safety control device is set up to detect the occurrence of a shutdown situation if the operating DC/DC converter and/or the backup supply DC/DC converter is faulty. This allows a safe state to be reliably established in such fault situations.

In one embodiment, the safety control device and/or the inverter circuit each have at least two power supply circuits, wherein a first of the at least two power supply circuits is supplied or can be supplied with energy from the low-voltage branch, and a second of the at least two power supply circuits is supplied or can be supplied with energy from the backup supply branch. Such a solution with two (in particular redundant) power supply circuits means that a connection point between the low-voltage branch and the backup supply branch can be avoided, which also simplifies or possibly eliminates the need for the above-mentioned blocking circuit. A power supply circuit is used to generate the required voltages in the supplied component from an input voltage, in this case at the low-voltage level. Typically, a power supply circuit itself can have DC/DC converters, low dropout regulators (LDO), etc.

Further advantages and embodiments of the disclosure are shown in the description and the accompanying drawing.

The disclosure is illustrated schematically in the drawing by means of embodiment examples and is described below with reference to the drawing.

### BRIEF DESCRIPTION OF THE DRAWINGS

FIG. 1 schematically shows an inverter, in embodiments.

FIG. 2 schematically shows a further inverter, in embodiments.

FIG. 3 schematically shows an inverter circuit as it can be used in an inverter, in embodiments.

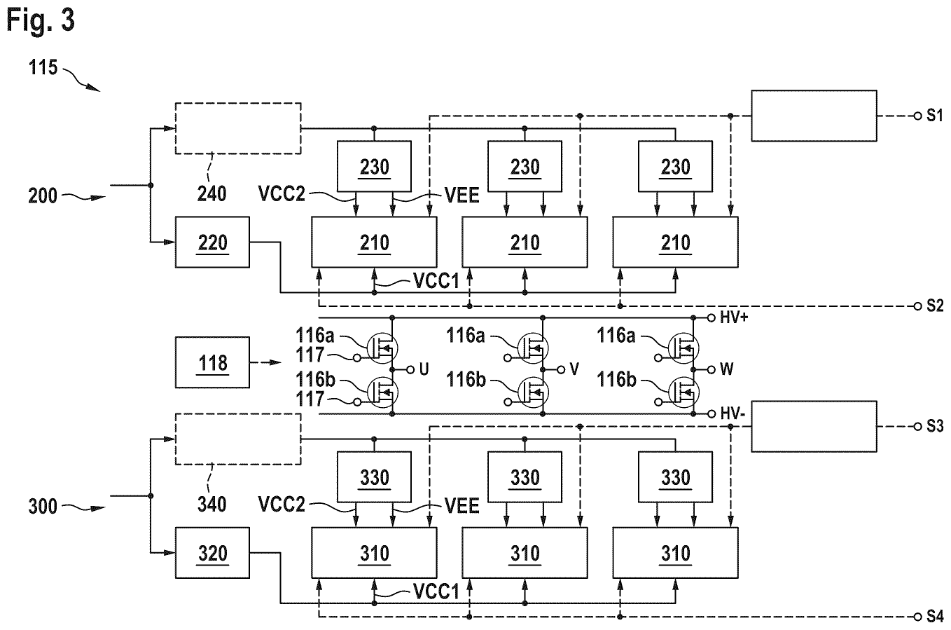

FIG. 4 schematically shows a further inverter, in embodiments.

FIG. 5 schematically shows a further inverter circuit, as can be used in an inverter as shown in FIG. 4, in embodiments.

FIG. 6 schematically shows a further inverter circuit, as can be used in an inverter as shown in FIG. 4, in embodiments.

FIG. 7 schematically shows a further inverter according, in embodiments.

FIG. 8 schematically shows a further inverter, in embodiments.

FIG. 9 schematically shows a safety disconnector as it can be used in an inverter, in embodiments.

### DETAILED DESCRIPTION

In the following, embodiments of the disclosure are described in a coherent and comprehensive manner with reference to the figures. In order to reduce the complexity of the figures, not all connections and signal flows are shown. Signal flows shown in the figures are used to request the safe state (safe-to-state requirements or ASC requirements for the HS and LS gate drivers). Return lines or earth or negative lines are also not shown in all events.

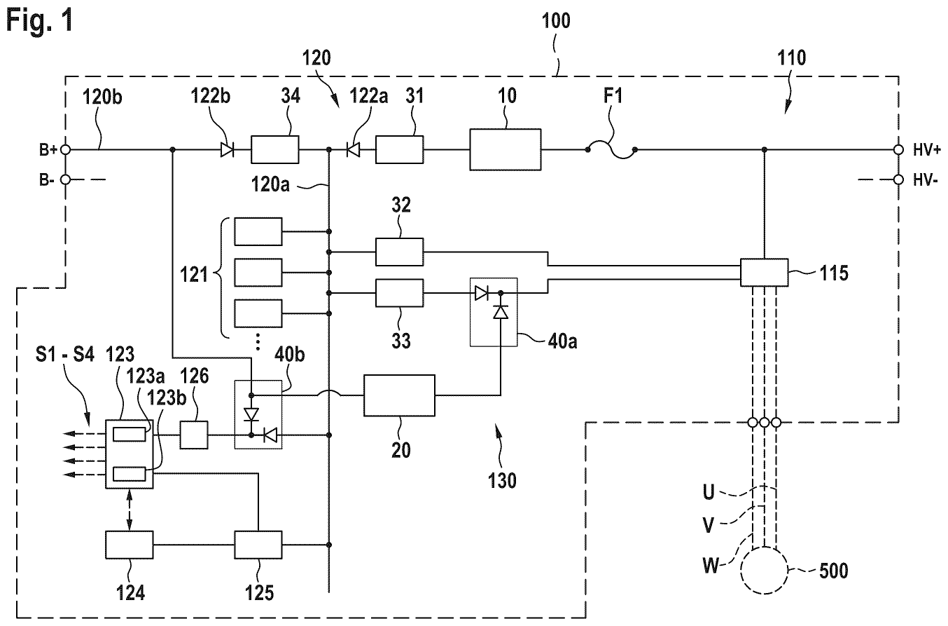

FIGS. 1, 2, 4, 7 and 8 schematically show slightly different embodiments of an inverter 100 according to the disclosure. In vehicles, an inverter is usually a component or device that controls the electrical machine. In particular, the inverter can implement torque and speed control and convert the DC voltage on the vehicle electrical network side into AC voltage on the engine side and-in the case of recuperation-vice versa, convert the AC voltage on the engine side into DC voltage on the vehicle electrical network side and feed it into the vehicle electrical network.

The inverter 100 has a high-voltage branch 110 with a high-voltage terminal HV+, HV− for connecting a high-voltage network with a high-voltage level, a low-voltage branch 120 with a low-voltage terminal B+, B− for connecting a low-voltage network (so-called KI.30 network) with a low-voltage level and a backup supply branch 130 with the low-voltage level. The high-voltage level is in the range from 40 V to 1,000 V, for example. The low-voltage level can be 12 V or 24 V, for example.

The high-voltage branch 110 is connected to the low-voltage branch 120 via an operating DC/DC converter 10.

The low-voltage branch 120 has a supply branch 120a, which in the broadest sense serves to supply power to the components of the inverter 1, and a mains branch 120b, which is connected to the low-voltage network. The supply branch 120a can also be referred to as PDN (see above). The supply branch 120a is connected via diodes 122a, 122b as second blocking circuits on the one hand to the operating DC/DC converter 10 and on the other hand to the mains branch 120b. The mains branch 120b is connected to the equivalent mains branch 130 via a backup supply DC/DC converter 20.

An inverter circuit 115 is used to connect the AC voltage terminals U, V, W (three in the example shown) of an electrical machine 500, which is not part of the inverter 100, to the positive DC voltage terminal HV+ and the negative DC voltage terminal HV− of the high-voltage branch 110. For this purpose, the inverter circuit 115 can comprise a logic circuit 118 for generating control signals and a number of semiconductor switches 116a, 116b to be controlled by means of the control signals.

The inverter 100 has a housing from which the terminals HV+, HV−, B+, B−, U, V, W and, in particular, communication (e.g. CAN, LIN, etc.) and/or sensor (e.g. speed, angular position, temperature, etc.) and/or other terminals are led out. The inverter 100 can advantageously be structurally connected to the electrical machine 500, i.e. in particular attached to it.

The inverter circuit 115 has so-called high-side, HS switches 116a (each between an AC voltage terminal U, V, W of the electrical machine 500 and the positive DC voltage terminal HV+) and so-called low-side, LS switches 116b (each between an AC voltage terminal U, V, W of the electrical machine 500 and the negative DC voltage terminal HV−). A HS power supply circuit 200 is provided in the present case for controlling the HS switches 116a, and a HS power supply circuit 300 is provided in the present case for controlling the HS switches 116b. The elements of the HS power supply circuit 200 and the LS power supply circuit 300 are each provided with a reference sign increased by 100 and are described together in the following.

Each of the switches 116a, 116b has a control terminal 117 (e.g. gate terminal of a MOSFET or IGBT) to which a control signal is applied by a so-called gate driver circuit 210, 310 (hereinafter also referred to simply as gate driver) in order to switch the switch.

Modern isolated gate drivers generally require a low-voltage supply VCC1 for the primary side. This can usually be 5V or 3.3V and is generated from the low voltage via low dropout regulators (LDO) 220, 320, for example.

To turn on and off power semiconductor switches such as SiC MOSFET and IGBT, each gate driver usually requires two different voltage levels on the secondary side (i.e. on the side connected to the gate 117 of switches 116a, 116b): a positive level VCC2 (e.g. +20 V for SiC MOSFET) and a negative level VEE (e.g. −4 V for SiC MOSFET), but this is not limited to these two voltage levels.

In order to safely control the switches 116a, 116b under normal conditions and also during active short circuits, an isolated gate driver power supply, also referred to as an isolated bias voltage supply, is used. To increase the reliability of the system, three HS bias voltage supply circuits 230 are used for the HS gate drivers 210 and three LS bias voltage supply circuits 330 are used for the LS gate drivers 310. It should be noted that there are other ways to realize the bias voltage supply, for example, using a flyback transformer having a plurality of windings as the HS bias voltage supply circuit and using another flyback transformer also having a plurality of windings as the LS bias voltage supply circuit, which also results in isolated bias voltage supplies.

To realize a bias voltage supply, a voltage may be required that is above the nominal voltage level of the low-voltage branch 120 or backup supply branch 130. If, in such a case, the bias voltage supply circuits 230, 330 are not able to increase the voltage accordingly, pre-regulator power supply units 240, 340 can be used to supply the bias voltage supply circuits 230, 330. In particular, these pre-regulator power supply units 240, 340 also comprise a DC/DC converter and convert the low voltage (e.g. 12 V or 15 V) to a higher voltage (e.g. 24 V). If the isolated bias voltage supply circuits have the ability to increase the voltage sufficiently (e.g., using a boost-blocking converter), then these pre-regulator power supply units 240, 340 are not necessary.

Since modern gate drivers can receive a safety request (e.g. for ASC) on both the primary and the secondary side (the primary chip is isolated from the secondary chip of the gate driver), it can receive two (safe-state) signals S1, S2 and S3, S4 respectively; one (S2, S4) for the primary side and one (S1, S3) for the secondary side. These signals are shown with dashed lines.

Modern isolated gate drivers are capable of receiving two types of safety signals, an ASC enable signal (ASC_EN), which requests the safe state, and an ASC state signal (ASC_ST), which specifies the type of safe state. To reduce the complexity of the figures, only one signal S1 to S4 per side (primary, secondary) is shown. However, it should be noted that each of the signals S1 to S4 can internally comprise several types of safety signals.

Furthermore, one or more low-voltage consumers 121 of the inverter 100, which are only indicated schematically, are arranged in the supply branch 120a, e.g. sensors (e.g. speed, angular position, temperature, etc.), communication devices (CAN transceiver, LIN transceiver, etc.), etc.

Furthermore, a (functional) safety control device 123 is provided in the supply branch 120a, i.e. a functional safety control device. The task of such a safety control device is, in particular, to monitor the inverter 100, to determine the state of the inverter 100 and, if necessary, to aggregate the signals S1 to S4 for the safe state so that the inverter circuit can operate with normal drive control or switch to a safe state such as ASC or the like. In order to realize this, it is advantageous if the safety control device 123 communicates with as many components or modules of the inverter 100 as possible and also with a higher-level or supervisory controller 124, such as a so-called MCU (motor control unit), in order to achieve a desired “Automotive Safety Integrity Level” (ASIL) in particular (depending on the functional safety objectives). The communication and signal transmission between the safety control device 123 and the supervisory controller 124 is shown as a double arrow with a dashed line.

To increase safety, a power management circuit 125 for the power supply is provided for the supervisory controller 124, for example in the form of a so-called PMIC (power management IC, integrated circuit) or safety PMIC. A safety PMIC integrates several DC/DC converters in one housing. The component usually has built-in protective functions such as soft start, pulse current limiting, independent voltage monitoring, temperature measurement and shutdown in the event of excessive power loss. A PMIC usually has a watchdog timer to ensure the integrity of the microcontroller used in the system.

The safety control device 123 is supplied with power or energy by a power supply circuit 126. To increase safety, the safety control device 123 is also simultaneously supplied with power by the power management circuit 125. In order to achieve the objective of functional safety (e.g. ASIL D), the safety control device 123 may have two separate safety logic circuits 123a, 123b which have two independent power supplies. The first safety logic circuit 123a is supplied by the power supply circuit 126 and the second safety logic circuit 123b is supplied by the power management circuit 125. In the event of a power failure in one of the two safety logic circuits, the other safety logic circuit can ensure the transition to a safe state.

In some concepts, the safety control device 123 and the supervisory controller 124 are powered only by the power management circuit 125, although a second source is usually considered to increase reliability and ensure fulfillment of the functional safety objective.

In order to achieve a desired level of functional safety, the safety control device 123 and the supervisory controller 124 can be supplied with various measurement signals, such as temperatures, speed, the voltage of various parts of the inverter circuit or the vehicle electrical network, etc., error or health states/signals from power supplies, sensors, gate drivers, main switches, etc.

In inverters not according to the disclosure without a backup supply branch 130, faults (open circuit or short circuit) may lead to an interruption of the power supply for the supply branch 120a or to a latent fault and affect the safety control device 123 or the power supplies of the gate drivers in such a way that a transition to the safe state for the inverter circuit 115 is not possible. In order to counter such situations advantageously, additional precautions are taken in the inverter, which are described below.

Additional safety disconnectors 31 to 34 are added to the inverter to protect the power supply as a whole and to isolate faulty areas from the rest of the network. The safety disconnectors 31 to 34 prevent a fault from propagating in the inverter and also latent faults. The safety disconnectors 31 to 34 can communicate with the safety control device 123 and supervisory controller 124 (communication links not shown).

The safety control device 123 is set up to bring the inverter circuit 115 into a safe state if a shutdown situation occurs, the occurrence of a shutdown situation being detected in particular if at least one of the safety disconnectors 31 to 34 is in an open state.

A first safety disconnector 31 is added in series with the operating DC/DC converter 10. When a fault occurs in the operating DC/DC converter 10, the first safety disconnector 31 may open, thereby protecting the supply branch 120a and interrupting the fault current, as well as informing the safety control device 123 and/or the supervisory controller 124 of the fault (if necessary). The LS power supply circuit 300 and safety control device 123 can then be supplied from the mains branch 120b and/or from the backup supply branch 130.

A second safety disconnector 32 is added in series with the HS power supply circuit 200. If a fault occurs in the HS power supply circuit 200, the second safety disconnector 32 can open, thereby protecting the supply branch 120a from fault propagation and interrupting the fault current, as well as informing the safety control device 123 and/or the supervisory controller 124 of the fault (if necessary).

A third safety disconnector 33 is added in series with the LS power supply circuit 300. If a fault occurs in the LS power supply circuit 300, the third safety disconnector 33 can open, thereby protecting the supply branch 120a and interrupting the fault current, as well as informing the safety control device 123 and/or the supervisory controller 124 of the fault (if necessary). The LS power supply circuit 300 can then be supplied from the high-voltage branch 110 via the backup supply branch 130.

A fourth safety disconnector 34 is added in the mains branch 120b. If a fault occurs in the supply branch 120a, the fourth safety disconnector 34 can open, thereby protecting the low-voltage network and the backup supply branch 130 and interrupting the fault current, as well as informing the safety control device 123 and supervisory controller 124 of the fault (if necessary).

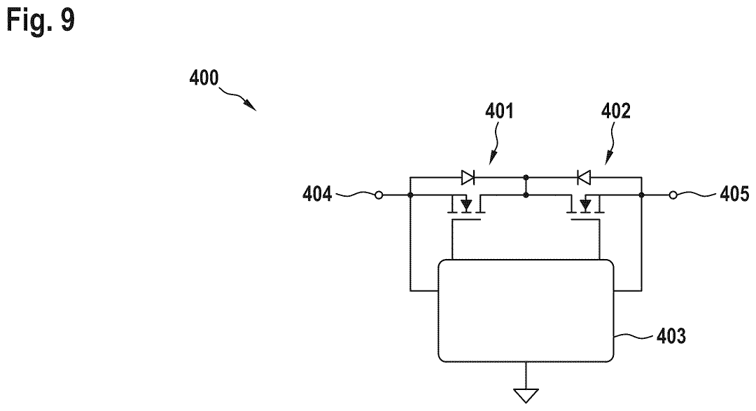

All these safety disconnectors 31 to 34 can be designed as diagnostic and monitoring modules with an integrated control circuit and protect against short circuits, ground faults, overvoltage and also undervoltage, or block reverse currents. An example of a simplified safety disconnector 400 is shown in FIG. 9. In general, a safety disconnector 400 can be implemented using electronic switches 401, 402 such as MOSFETs and a control circuit 403 that receives signals, in particular with respect to current and/or voltage, from input 404 and output 405 and controls the gate of the MOSFETs. The control circuit 403 is alternatively or additionally set up to open or close the electronic switches 401, 402 in accordance with a control signal, in particular from the safety control device 123 or the supervisory controller 124.

As shown in FIGS. 1, 2, 4, 7 and 8, the low-voltage branch 120 or the low-voltage network is connected to the backup supply branch 130 via a backup supply DC/DC converter 20. This converts the low voltage (e.g. close to 12 V, or even less in certain situations) into a slightly higher low voltage (e.g. 15-20 V). The backup supply branch 130 provides a connection to the LS power supply circuit 300 and also to the safety control device 123. Alternatively (not shown), the backup supply branch 130 may also connect to the HS power supply circuit 200 and the safety control device 123.

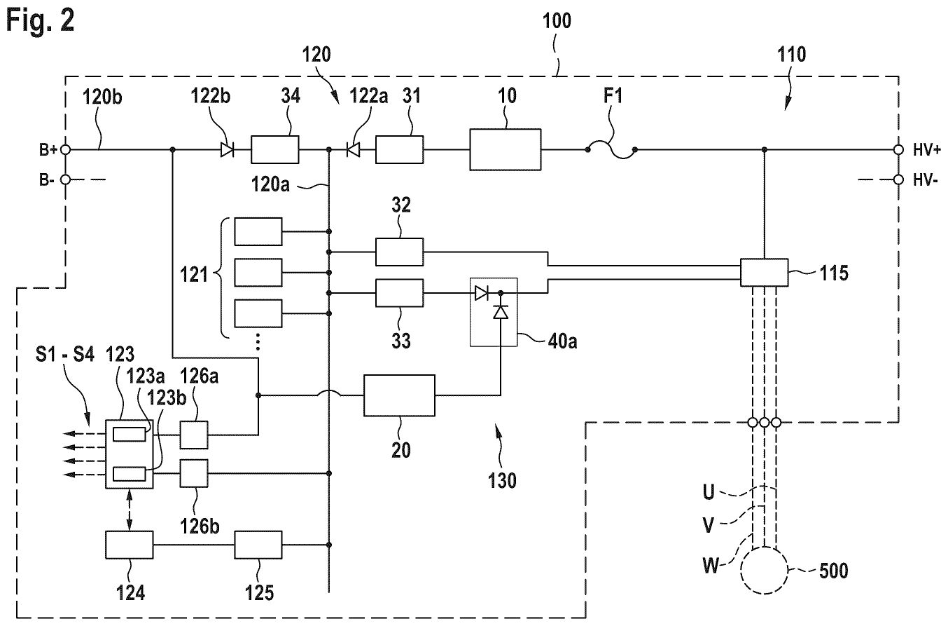

In FIGS. 1 and 2, the power supply circuit 300 is connected to the backup supply branch 130 via a blocking circuit 40a. In one embodiment, the blocking circuit 40a may include two diodes as shown. When the supply branch 120a is supplied, the LS power supply circuit 300 is supplied from the supply branch 120a. If the supply from the supply branch 120a fails, the third safety disconnector 33 disconnects the LS power supply circuit 300 from the supply branch 120a, and the LS power supply circuit 300 is supplied from the backup supply branch 130.

In FIG. 1, the safety control device 123 is connected to the backup supply branch 130 via a blocking circuit 40b. In one embodiment, the blocking circuit 40b may comprise two diodes, as shown.

In FIGS. 2, 4, 7 and 8, the safety control device 123 is connected to the backup supply branch 130 via a first power supply circuit 126a, and is connected to the supply branch 120a via a second power supply circuit 126b. The blocking circuit 40b is omitted.

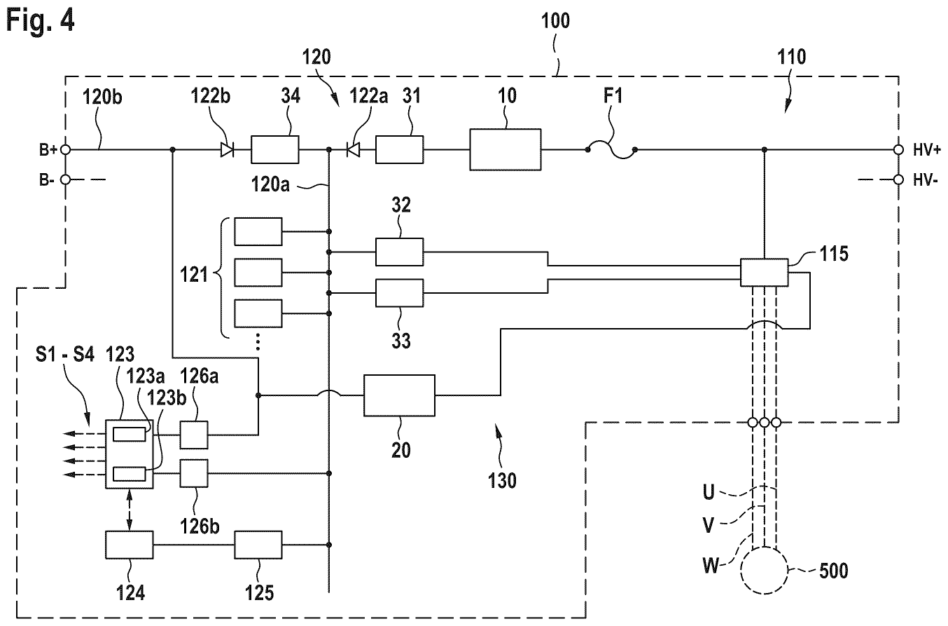

FIGS. 4, 7 and 8 schematically show further embodiments of an inverter 100 according to the disclosure, which differ from the embodiment according to FIG. 2 in that the blocking circuit 40a is omitted.

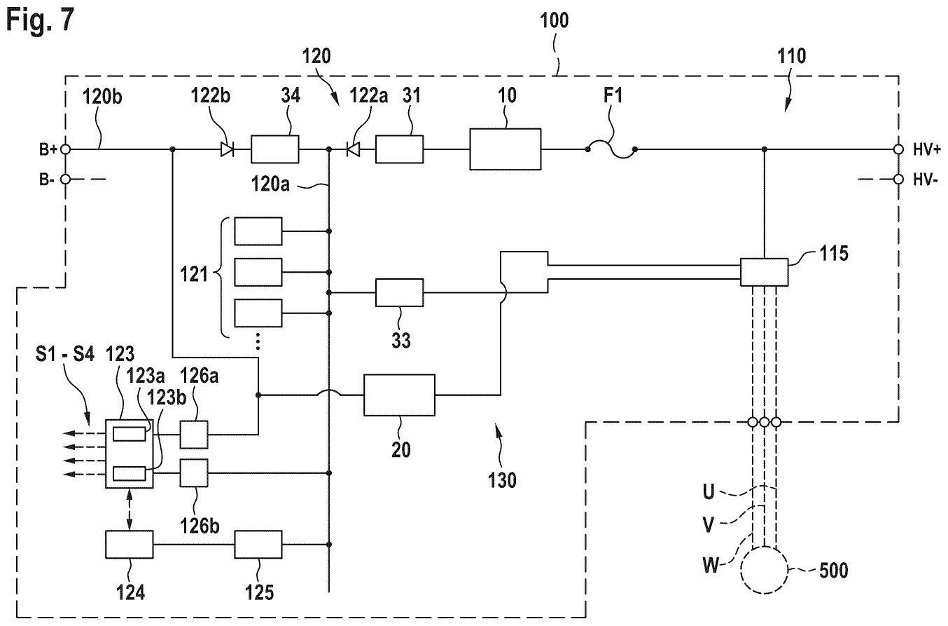

FIGS. 1, 2, 4 and 8 show embodiments in which at least the at least one gate driver circuit 310 for the low-side semiconductor switches 116b is supplied or can be supplied with energy from the backup supply branch 130. In FIG. 7, an embodiment is shown in which at least the at least one gate driver circuit 210 for the high-side semiconductor switches 116a is supplied or can be supplied with energy from the backup supply branch 130.

When the supply branch 120a is supplied, the safety control device 123 is supplied from the supply branch 120a, which in turn is supplied from the low-voltage network and the high-voltage branch 110. If the supply from the supply branch 120a fails, the safety control device 123 or its first safety logic circuit 123a is supplied from the backup supply branch 130.

A further option, which is not shown in the figure, is to also connect the power management circuit 125 to the backup supply branch 130 via a further blocking circuit.

The blocking circuits help to prevent current flow to other parts of the inverter, which can lead to an overload of the backup supply DC/DC converter 20 or to the fault being fed into other sub-networks.

To protect the primary and secondary sides of the operating DC/DC converter 10, a fuse F1 is provided as a high-voltage disconnector so that in the event of a fault on the primary side, e.g. a short circuit in a transformer winding of an electrically isolated DC/DC converter or a short-circuited switch, the fuse isolates the faulty section.

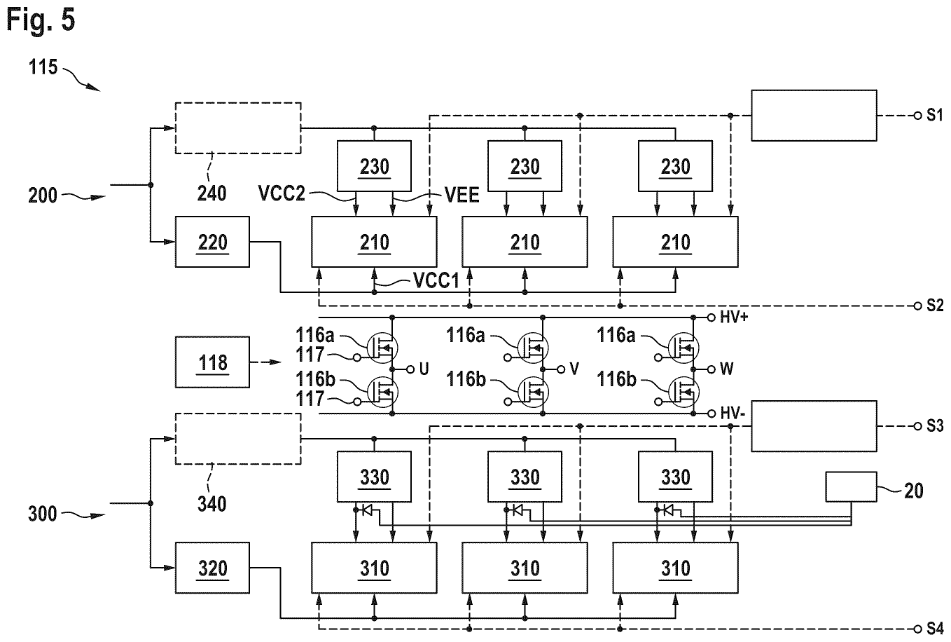

As can be seen in connection with FIG. 5, where a further embodiment of an inverter circuit is shown, in FIG. 4, the equivalent supply branch 130 may be connected to each voltage supply line VCC2 between the three LS bias voltage supply circuits 330 and the LS gate drivers 310 via the backup supply DC/DC converter 20 and a blocking diode, respectively.

This only guarantees the supply required for the LS gate driver 310 to initiate the safe state and is not suitable for continuous operation. It is therefore sufficient to contact only the power supply line VCC2 to provide only the power for the gate driver to enter the safe state.

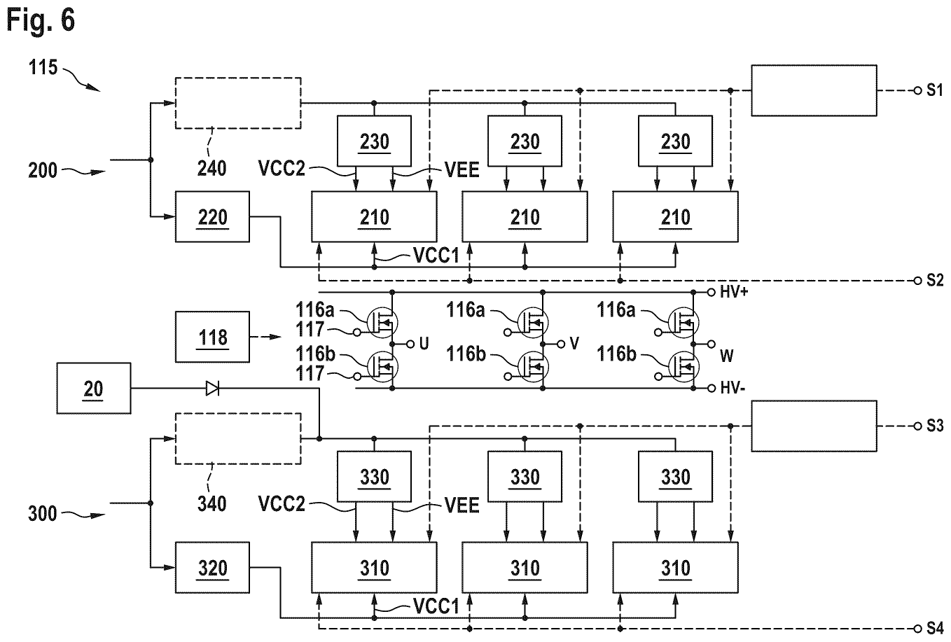

As can be seen in connection with FIG. 6, where a further embodiment of an inverter circuit is shown, in FIG. 4 the backup supply branch 130 can alternatively also supply the three LS bias voltage supply circuits 330 via the backup supply DC/DC converter 20.

This also only guarantees the supply required for the LS gate driver 310 to initiate the safe state and is not suitable for continuous operation. It is therefore sufficient to supply only the three LS bias voltage supply circuits 330 in order to provide only the energy for the gate driver to enter the safe state.

The backup supply branch 130 can also be connected to the first power supply circuit 126a and the first safety logic circuit 123a of the (functional) safety control device 123. This connection supplies the first safety logic circuit 123a with power in all operating states. In the event of a failure of the supply branch 120a, the second safety logic circuit 123b may lose the supply, but the first safety logic circuit 123a may be activated and initiate the safe state for the LS gate drivers, as they are also supplied by the backup power supply.

With the inverter 100 as shown in FIG. 7, the HS power supply circuit 200 is supplied from the backup supply branch 130. The second safety disconnector 32 is omitted. The first safety logic circuit 123a is also supplied from the backup supply branch 130 as before.

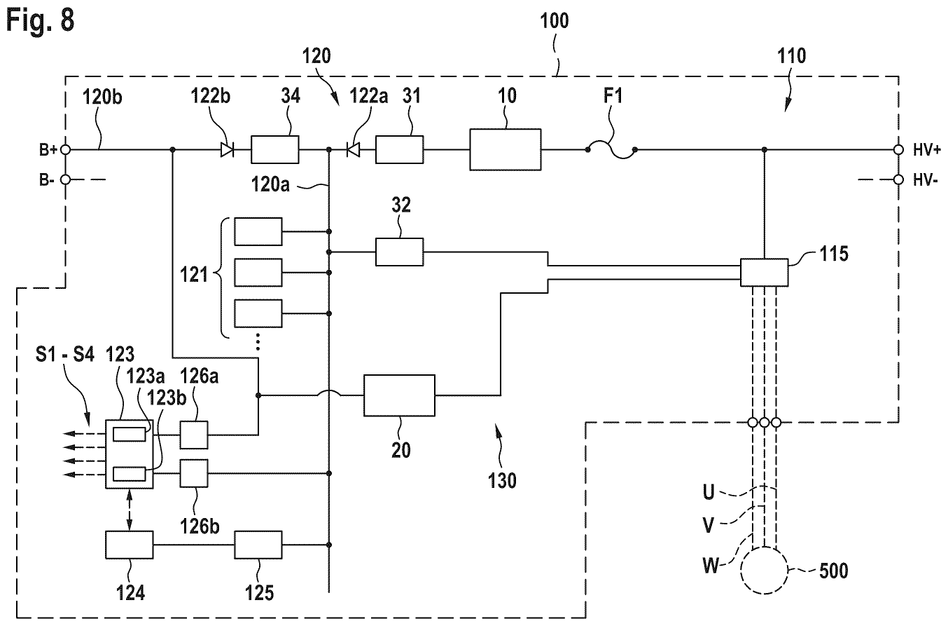

With the inverter 100 as shown in FIG. 8, the LS power supply circuit 300 is supplied from the backup supply branch 130. The third safety disconnector 33 is omitted. The first safety logic circuit 123a is also supplied from the backup supply branch 130 as before.

In all the variants shown, faults in the supply branch 120a and in the backup supply branch 130 are isolated from each other. The fault can therefore not be passed on from the supply branch 120a to the backup supply branch 130 and vice versa.

If a fault occurs in the supply branch 120a or in the high-voltage branch 110, the backup supply branch 130 can guarantee the supply of the first safety logic circuit 123a and the respective LS or HS power supply circuit 200, 300 (only one of them). The execution of the safe state is therefore guaranteed.

The disclosure can increase functional safety and reliability without the need to prove complete redundancy for the inverter, which would increase costs by a factor of 2. Advantageously, the size of the backup supply DC/DC converter does not have to be large enough to supply the entire inverter, which leads to a cost reduction when implementing this concept.

1. An inverter (100) for controlling an electrical machine (500), the inverter (100) having
a high-voltage branch (110), a low-voltage branch (120) and a backup supply branch (130),
an operating DC/DC converter (10), which is connected on the one hand to the high-voltage branch (110) and on the other hand to the low-voltage branch (120),
a backup supply DC/DC converter (20), which is connected on the one hand to the low-voltage branch (120) and on the other hand to the backup supply branch (130),
an inverter circuit (115) for connecting the high-voltage branch (110) to AC voltage terminals (U, V, W) for the electrical machine (500),
the inverter circuit (115) and a safety control device (123) being supplied with energy from the low-voltage branch (120),
the safety control device (123) being set up to switch the inverter circuit (115) to a safe state when a shutdown situation occurs,
wherein the inverter circuit (115) and the safety control device (123) are supplied or can be supplied with energy from the backup supply branch (130).

2. The inverter (100) according to claim 1,
wherein a blocking circuit (40a, 40b) is arranged between the low-voltage branch (120) and the backup supply branch (130), which prevents a flow of energy between the low-voltage branch (120) and the backup supply branch (130).

3. The inverter (100) according to claim 1,
wherein the low-voltage branch (120) comprises
a supply branch (120a) and a mains branch (120b), wherein the inverter circuit (115) and the safety control device (123) are supplied with energy from the supply branch (120a),
wherein the mains branch (120b) is arranged to be connected to a voltage supply,
wherein a second blocking circuit (122a, 122b, 31, 34) is arranged between the supply branch (120a) and the operating DC/DC converter (10), which prevents a flow of energy from the supply branch (120a) into the operating DC/DC converter (10),
and/or wherein the second blocking circuit (122a, 122b, 31, 34) is arranged between the supply branch (120a) and the mains branch (120b), which prevents a flow of energy from the supply branch (120a) into the mains branch (120b).

4. The inverter (100) according claim 1,
wherein the operating DC/DC converter (10) is disconnectable from the low-voltage branch (120) by means of a first safety disconnector (31) and/or is disconnectable from the high-voltage branch (110) by means of a first high-voltage disconnector (F1).

5. The inverter (100) according to claim 1,
wherein the inverter circuit (115) comprises a number of high-side semiconductor switches (116a) and a number of low-side semiconductor switches (116b) and at least one gate driver circuit (210; 310) for the high-side and low-side semiconductor switches,
wherein the at least one gate driver circuit (210; 310) is powered from the low-voltage branch (120) or the supply branch (120a).

6. The inverter (100) according to claim 5,
wherein the at least one gate driver circuit (210; 310) for the high-side and low-side semiconductor switches comprises at least one gate driver circuit (210) for the high-side semiconductor switches (116a) which can be disconnected from the low-voltage branch (120) by means of a second safety disconnector (32).

7. The inverter (100) according to claim 5,
wherein the at least one gate driver circuit (210; 310) for the high-side and low-side semiconductor switches comprises at least one gate driver circuit (310) for the low-side semiconductor switches (116b) which can be disconnected from the low-voltage branch (120) by means of a third safety disconnector (33).

8. The inverter (100) according claim 5,
wherein the at least one gate driver circuit (210; 310) for the high-side and low-side semiconductor switches is or can be supplied with energy from the backup supply branch (130).

9. The inverter (100) according claim 5,
wherein the at least one gate driver circuit (210; 310) for the high-side and low-side semiconductor switches comprises exactly one gate driver circuit (210; 310) for each of the high-side semiconductor switches (116a) and/or low-side semiconductor switches (116b).

10. The inverter (100) according to claim 5,
wherein the at least one gate driver circuit (210; 310) for the high-side and low-side semiconductor switches is powered by at least one bias voltage supply circuit (230; 330), wherein the at least one gate driver circuit (210; 310) for the high-side and low-side semiconductor switches and/or the at least one bias voltage supply circuit (230; 330) is powered from the low-voltage branch (120).

11. The inverter (100) according to claim 10, wherein a connecting line (VCC2) between the at least one gate driver circuit (210; 310) for the high-side and low-side semiconductor switches, and the at least one bias voltage supply circuit (230; 330) is connected to the low-voltage branch (120).

12. The inverter (100) according to claim 1,
wherein the supply branch (120a) is disconnectable from the mains branch (120b) and/or the backup supply branch (130) by means of a fourth safety disconnector (34).

13. The inverter (100) according to claim 12,
wherein the safety control device (123) is adapted to detect the occurrence of a shutdown situation when at least one of the first, second, third and fourth safety disconnectors (31-34) is in a non-conductive state.

14. The inverter (100) according to claim 12,
wherein at least one of the first, second, third and fourth safety disconnectors (31-34) comprises at least one electronic switch (401, 402) between an input (404) and an output (405) and a control circuit (403), wherein the control circuit (403) is arranged to open or close the at least one electronic switch (401, 402) in accordance with a control signal.

15. The inverter (100) according to claim 1,
wherein at least one of the safety control device (123) and the inverter circuit (115) comprises at least two safety logic circuits (123a, 123b), wherein a first (123a) of the at least two safety logic circuits is supplied or can be supplied with energy from the low-voltage branch (120) and a second (123b) of the at least two safety logic circuits is supplied or can be supplied with energy from the backup supply branch (130).

16. A method of operating an inverter (100) according to claim 1, comprising:
in the occurrence of a shutdown situation, bringing the inverter circuit (115) into a safe state.

17. The method according to claim 16, comprising:
detecting that a shutdown situation exists when at least one of the first, second, third and fourth safety disconnectors (31-34) detects a fault and/or when at least one of the first, second, third and fourth safety disconnectors (31-34) is in an open state.

18. The method according to claim 16, comprising:
detecting that a shutdown situation exists when a fault occurs in the operating DC/DC converter (10) and/or the backup supply DC/DC converter (20).

19. The method according to claim 16, comprising:
detecting that a shutdown situation occurs when the at least one gate driver circuit (210; 310) for the high-side and low-side semiconductor switches detects a fault, in particular in the power supply from the low-voltage branch (120).

20. A safety control device (123) adapted to perform a method of operating the inverter (100) of claim 1, comprising in the occurrence of a shutdown situation, bringing the inverter circuit (115) into a safe state.
